(19) United States
(12) Patent Application Publication
(10) Pub. No.: US 2012/0252570 A1
(43) Pub. Date: Oct. 4, 2012

(54) METHOD FOR VIRTUAL FRIENDSHIP AND ACCESSING RESTRICTED PORTIONS OF VIRTUAL WORLDS

(75) Inventors: Michael Kwant, Scarborough (CA); Karl Joseph Borst, Woodbridge (CA)

(73) Assignee: GANZ, Woodbridge (CA)

(21) Appl. No.: 13/434,032

(22) Filed: Mar. 29, 2012

Related U.S. Application Data
(60) Provisional application No. 61/468,739, filed on Mar. 29, 2011.

(51) Int. Cl. G06F 17/00

(52) U.S. Cl. 463/29; 463/43

(57) ABSTRACT

Provided is a method of interacting with a non-player character in a virtual world. With a computer system, a user is granted access to an interface allowing the user to establish a friendship with a computer-controlled character. Such a friendship is established by adding the computer-controlled character to a list of friends associated with the user. The user is then granted access to a restricted portion of the virtual world that was not accessible to the user before the user entered the friendship request.

### CROSS-REFERENCES TO RELATED APPLICATIONS

This application claims the benefit of provisional application Ser. No. 61/468,739 filed on Mar. 29, 2011, incorporated herein by reference in its entirety.

The disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This application relates generally to users interacting in a virtual world with non-player characters (NPCs). The application also relates to users being presented with a challenge to be completed within the virtual world and granting access to a restricted portion of the virtual world based on, for example, the completion of the challenge.

### BACKGROUND OF THE INVENTION

Virtual worlds are computer based environments in which different users interact with each other. These computer based environments allow users to communicate with one another, participate in gaming, and participate in many other activities. User's often control virtual characters, commonly referred to as avatars, that move throughout the virtual world and interact with other virtual character's belonging to, and being controlled by other human users. The human users themselves can become familiar with other uses they interact with on a regular basis.

However, virtual worlds have also included computer-controlled, or “non-player” characters that are automated, and controlled entirely by a computer system, including the computer system that hosts the virtual world. In early virtual worlds, these non-player characters would be confined to acting as an enemy of the user. Therefore, interaction between the user's virtual character and the non-player character has traditionally been limited to combat and other adversarial confrontations. Thus, such traditional systems have lacked friendly, cooperative relationships between virtual characters controlled by users and computer-controlled characters controlled by a computer system.

### SUMMARY OF THE INVENTION

Provided is a method for interacting with a non-player character in a virtual world. The method comprises step of: presenting a user with an ability to befriend a non-player character. The method also includes receiving a friendship request from the user for a friendship with the non-player character and adding the non-player character to a friendship list of the user. The method further includes in response to establishing the friendship with the non-player character, granting access to the user to a restricted portion of the virtual world.

Also provided is a method for unlocking portions of a virtual world including granting a user access to a virtual character within the virtual world. The method also includes in response to receiving input commands from the user, controlling movement of the virtual character within the virtual world in a manner consistent with the input commands. The method also includes restricting access to a restricted portion of the virtual world to prevent the user from participating in an activity in the restricted portion or accessing an area in the restricted portion of the virtual world and presenting a plurality of steps to the user for unlocking access to the restricted portion of the virtual world, and requiring the user to complete a current event in each one of the plurality of steps before attempting a subsequent event. The method further includes providing a hint option in at least one of the plurality of steps, which if chosen by the user, assists the user in completing the current event. The method also includes in response to the user correctly responding to all of the plurality of steps, unlocking access to the restricted portion of the virtual world.

Further provided is a method for unlocking portions of a virtual world while interacting with a non-player character. The method includes restricting access to a restricted portion of the virtual world; presenting a user with an ability to befriend a non-player character; and receiving a friendship request from the user for a friendship with the non-player character. The method also includes establishing a friendship between the user and the non-player character by adding the non-player character to a friendship list of the user. The method further includes in response to said establishing the friendship with the non-player character, granting access to the user to a restricted portion of the virtual world and maintaining a friendship level representing a closeness of the friendship between the user and the non-player character. The method also includes presenting a challenge comprising a plurality of steps to the user for unlocking access to the restricted portion of the virtual world upon completion of each of the plurality of steps. The user is required to complete a current event in each one of the plurality of steps before attempting a subsequent event. The method further includes providing a hint option in at least one of the plurality of steps, which if chosen by the user, assists the user in completing the current event.

### BRIEF DESCRIPTION OF THE DRAWINGS

FIG. 1 graphically depicts an illustrative embodiment of a method for interacting with a non-player character in a virtual world;

FIG. 2A shows an illustrative embodiment of an activity invitation interface within a tournament area of the virtual world;

FIG. 2B shows an illustrative embodiment of a matchup interface illustrating the opponent/teammate for an activity in the tournament area;

FIG. 2C shows an illustrative embodiment of an activity interface where a user is competing against a non-player character in an activity;

FIG. 3 graphically depicts an illustrative embodiment of a method for creating and maintaining a friendship between a user and a non-player character;

FIG. 4 graphically depicts an illustrative embodiment of a method for unlocking portions of a virtual world;

FIG. 5 shows an illustrative embodiment of a computer system for providing a virtual world including computer-controlled characters;

FIG. 6 shows an illustrative embodiment of a computer-controlled character moving about in a virtual world hosted by the computer system shown in FIG. 5; and

FIG. 7 shows an illustrative embodiment of a computer-controlled character statically located in a virtual world hosted by the computer system shown in FIG. 5.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

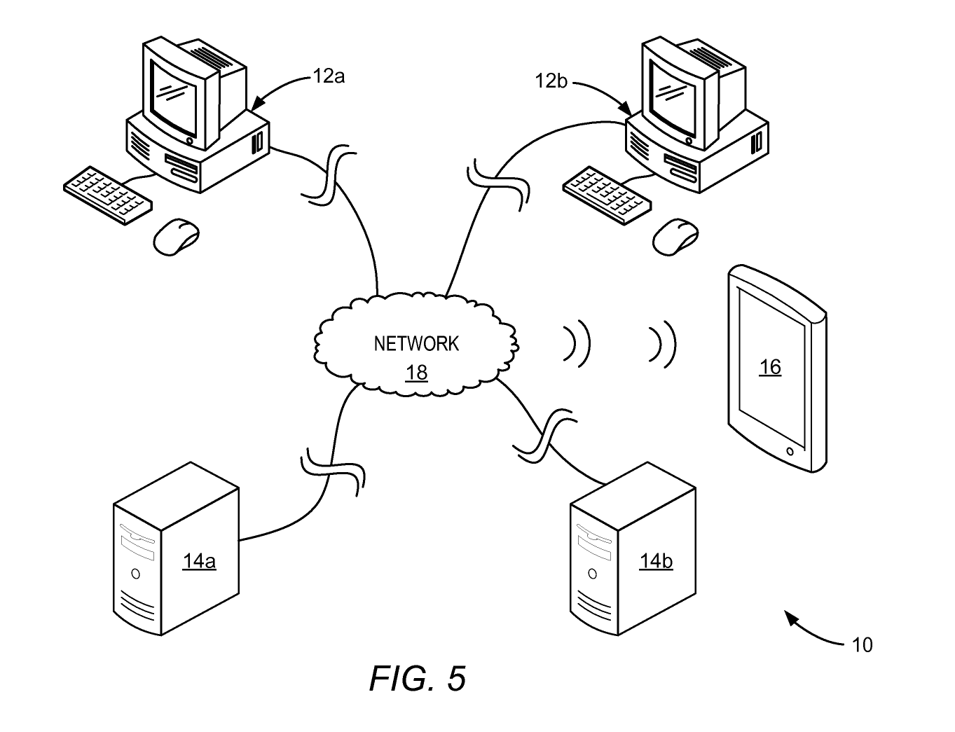

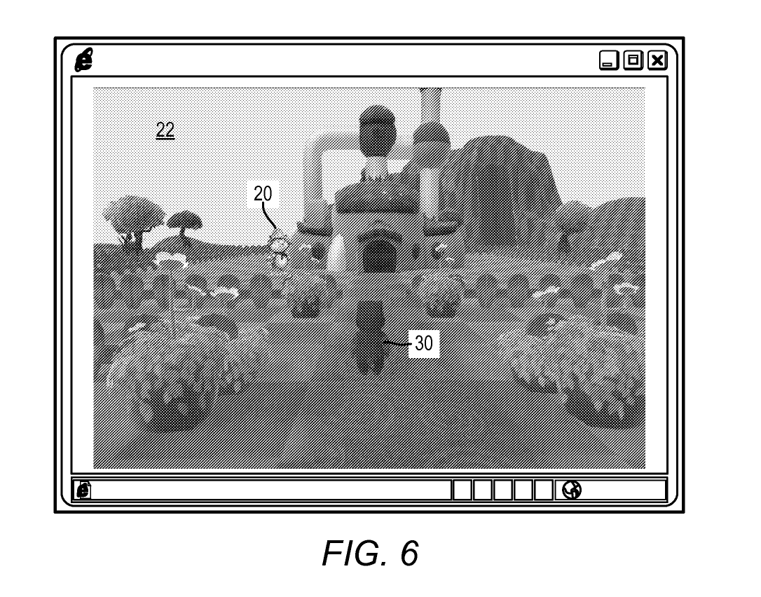

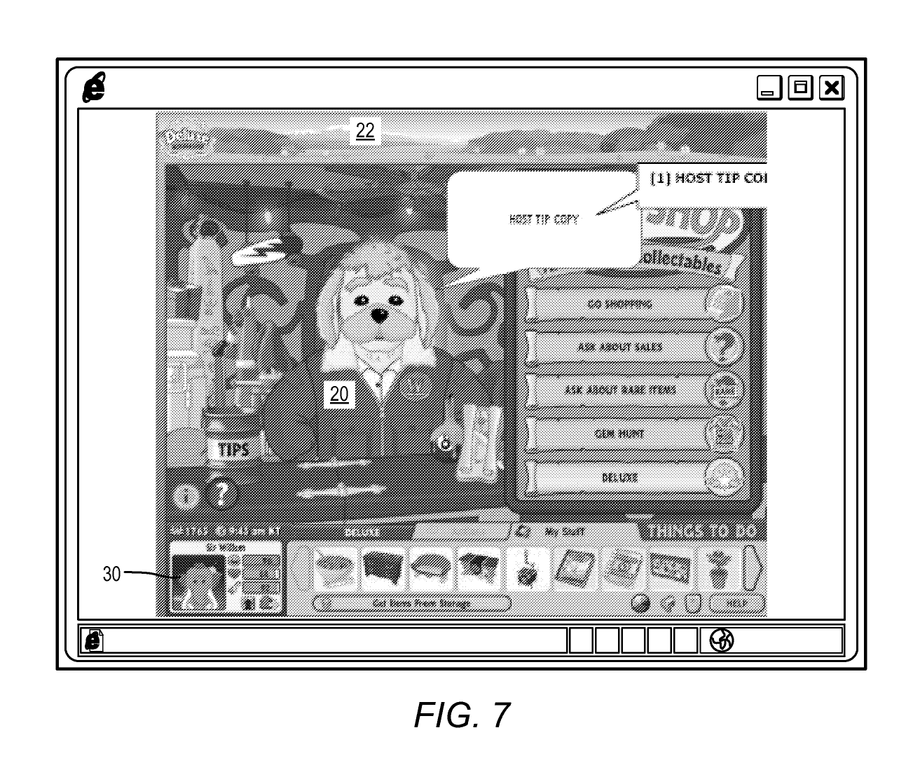

Provided is an Entertainment System including an online “virtual world”, represented generally at 22 (FIGS. 6 and 7). In one embodiment, the virtual world 22 is implemented using an interactive website via a user computer 12a, 12b (FIG. 5) connected to a communication network 18 such as the Internet. In this manner, a user can play inside the virtual world in a computer generated fantasy world (i.e., the virtual world).

Graphics, animation, sound, and even recorded images might be utilized to generate this virtual world. Even live images might be utilized, if desired. In addition, other sources of material can also be utilized. In essence, the virtual world creates an interactive playland for a user controlling a virtual character 30 by inputting control commands via a user computer 12a (FIG. 5).

Throughout this disclosure, the term “virtual” is used, for example, to describe the user viewable/hearable material presented to the user on the user computer from data and/or computer programs and commands generated and/or provided by the entertainment system, to the user computer running one or more computer applications (e.g., a web browser with the appropriate plug-ins, applets, and/or other support programs, etc.). The System provides the data and/or programs, via a communication network connected to the System and the user computer (e.g., the Internet).

The term “virtual” does not necessarily mean that the displayed item is not “real”, because the displayed item could, for example, be a video or picture of a real item, for example. Furthermore, the “virtual world” is presented using “real” physical phenomena (e.g., light and sound), and is impacted by “real” user interactions (e.g., mouse and keyboard manipulations). Rather, the term “virtual” is used to describe the computer generated and/or provided presentation to the user, including both visual and audible effects, via the user computer 12a (FIG. 5). It is a virtual world 22 in the sense that it is primarily a computer presented fantasy world with which the user can interact via manipulations of the user computer 12a. In this manner, the “virtual” items of the virtual world can be presented as interacting with each other and with the user. Furthermore, the user is provided access to games and trivia as well. An illustrative example of a virtual world of the type described herein is set forth in U.S. Pat. No. 8,002,605 to Ganz, which is incorporated in its entirety herein by reference.

The virtual world 22 may include a virtual representation of a toy with a unique registration number provided with the toy to purchase, to adopt the toy online, and to play with the virtual representation of the toy (the virtual representation of the toy being referred to herein as a “virtual character” 30) in the virtual world 22. In one embodiment, the virtual world 22 provides a biography of the toy, a virtual representation of the toy (the virtual toy) using graphics and/or sound (such as an animated image, for example) to participate in games and activities. The virtual world 22 may also provide a virtual means for maintaining the “health and well-being” of the character through various maintenance activities, such as virtual feeding and playing, virtual shopping, and virtual medical checkups.

The terms “award” and “gift” may be understood to include virtual awards and virtual gifts for items in the virtual world 22 but may also include awards that have value outside of the virtual world 22. Virtual awards and gifts may include virtual currency.

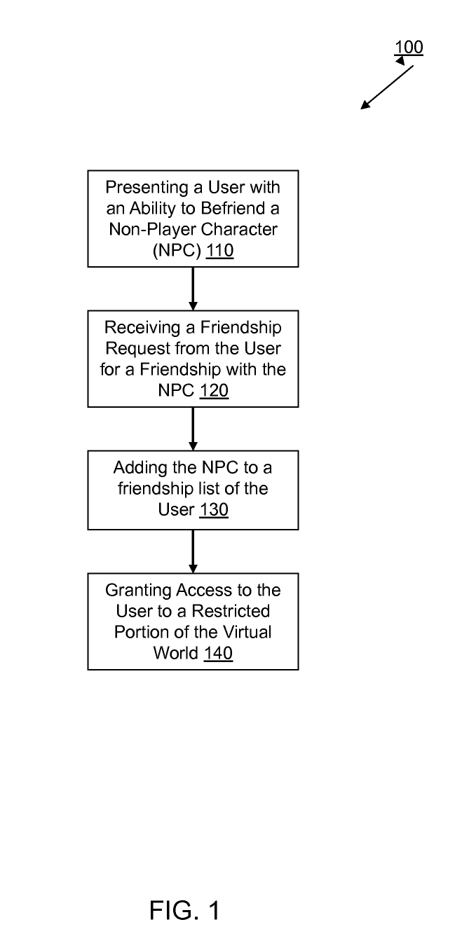

FIG. 1 shows a flowchart 100 for interacting with a “non-player character”, interchangeably referred to herein as a “computer-controlled character”, in a virtual world 22. This non-player character, in one embodiment, is a character that is completely controlled, in an automated manner, by the computer instead of in response to manually-input control commands entered by a human user at a time when the character is to perform an action in the virtual world, and there is no user who controls the non-player character's operation.

This flowchart of FIGS. 1, 3 and 4 can be carried out by a computer system 10, such as that schematically illustrated in FIG. 5 for example. The computer system can include at least one, and optionally a plurality of different computers. The embodiment shown in FIG. 5 is an example of a distributed computer system 10, which includes a plurality of client computers 12a, 12b used by different users, which can be remotely located from each other, and at least one, or optionally a plurality of servers 14a, 14b, and/or an optional mobile computer 16. The servers 14a, 14b can optionally be web servers for hosting a website for providing the virtual world 22 to the remotely-located user computers 12a, 12b. Each of the user computers 12a, 12b, the servers 14a, 14b and the mobile computer 16 includes a non-transitory, computer-readable memory that can store computer-executable instructions, data and other information pertaining to the virtual world 22. Likewise, each of the user computers 12a, 12b, the servers 14a, 14b and the mobile computer 16 also includes a computer processing component, volatile memory component, network interface, display device and other such hardware, along with appropriate drivers and other computer logic known in the art to support operation of such hardware.

The computers 12a, 12b, server(s) 14a, 14b, mobile computer(s) 16, are operatively connected to each other, to communicate with each other over a communication network 18, which can be implemented using any computer networking hardware and/or software as is known in the art. For example, the communication network 18 can include a wide area network (“WAN”), a local area network (“LAN”), or a combination thereof, and can facilitate communications over a public communication network such as the Internet, for example. As such, the computer system 10 is operable to provide a virtual world 22 over the communication network 18 to be accessible via a web browser application executed on the user computers 12a, 12b, for example, optionally as a game available as part of a social networking environment such as Facebook®, for example.

Although shown in FIG. 5 as a distributed computer system 10, alternate embodiments can include a local, stand-alone computer system, where all computer resources for providing the virtual world 22 and the computer-controlled characters described herein are included in a single terminal. Examples of the single terminal can optionally be a conventional personal desktop or laptop computers, hand-held gaming devices, or gaming consoles (e.g., Microsoft® Xbox®, Sony® Playstation®, etc. . . . ). Although such devices can communicate with other compatible devices over the communication network 18, they are operable to provide the virtual world 22 and computer-controlled characters as described herein even in the absence of an operable connection to the communication network 18.

Non-player characters, such as the non-player character 20 shown in FIG. 6, for example, may include characters that move about, and can be randomly encountered within the virtual world 22 by the virtual character 30 controlled by the user, an embodiment of the virtual world 22 being represented generally at 22. According to other embodiments, the non-player characters 20 can remain statically placed in the virtual world, or occasionally move through the virtual world 22, or a combination including a plurality of virtual characters, some moving about in the virtual world 22 and some being statically located. In some instances a non-player character may only appear in a menu, help box, or other non-geographical location in the virtual world 22. Yet other embodiments include the non-player character presented by a user computer 12a within the virtual world 22.

According to an illustrative embodiment, a server 14a executing computer-executable instructions or other portion of the computer system 10, can be operable to perform a method to facilitate interactions between a virtual character controlled by a user. The method includes presenting a user with an ability to befriend a non-player character 110. Upon receiving the option to select and befriend the non-player character, the user may choose to befriend the non-player character, for example, by clicking on a button that asks if the user would like to befriend the non-player character or by selecting the user's friendship request list which now includes the non-player character. This user selection is then received as a friendship request from the user for a friendship with the non-player character 120. In response to the request from the user, the non-player character may be added to a friendship list of the user 130. In another embodiment, the user may be added to the friendship list of the non-player character instead of, or in addition to the non-player character added to the friendship list of the user. Further, after befriending the non-player character or adding the non-player character to the user's friendship list, the user is granted access to a restricted portion of the virtual world 140.

The restricted portion of the virtual world 22 may be, for example, a virtual geographic area within the virtual world 22 or other content that is not associated with a specific area in the virtual world 22. The other content not associated with an area may be an activity, game (each generally referred to as an “activity” 34), challenge to answer a question or set of questions, email address of a user or non-player character, a text messaging, an email system, and the like. Thus, in response to befriending the non-player character 20, the restricted portion of the virtual world 22 may be made accessible to the user. In one example, the non-player character 20 can be a Host disposed within the virtual world 22. The Hosts may be associated with, or otherwise available to participate in an activity 34 available to the user within the tournament area of the virtual world 22. The user can participate in an activity 34 against, or in cooperation with the host non-player character 20. This tournament arena or area may be a restricted portion of the virtual world 22 not accessible to users that have not added the non-player character 20 with the particular host tournament to the user's list of friends. The tournament area can optionally be specific to one or a plurality of predetermined non-player characters 20, where only the one or plurality of non-player character(s) 20 are able to compete against or in cooperation with that/those non-player character(s) 20). The tournament arena or area may include games, challenges, and other activities where the user competes against or with the Host non-player character 20.

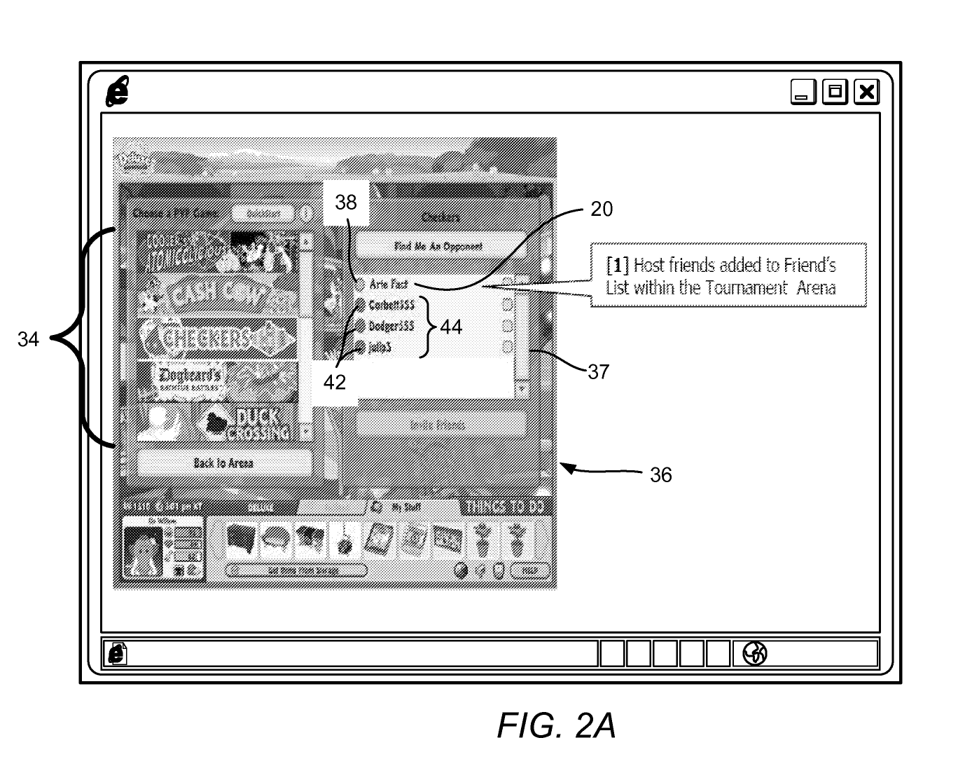

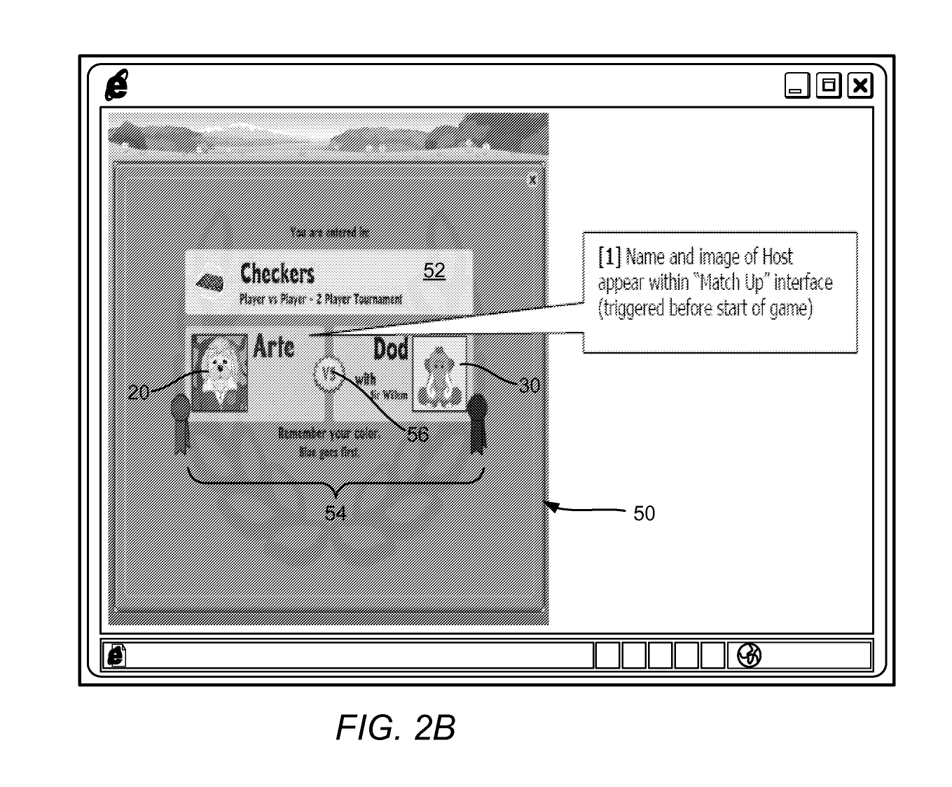

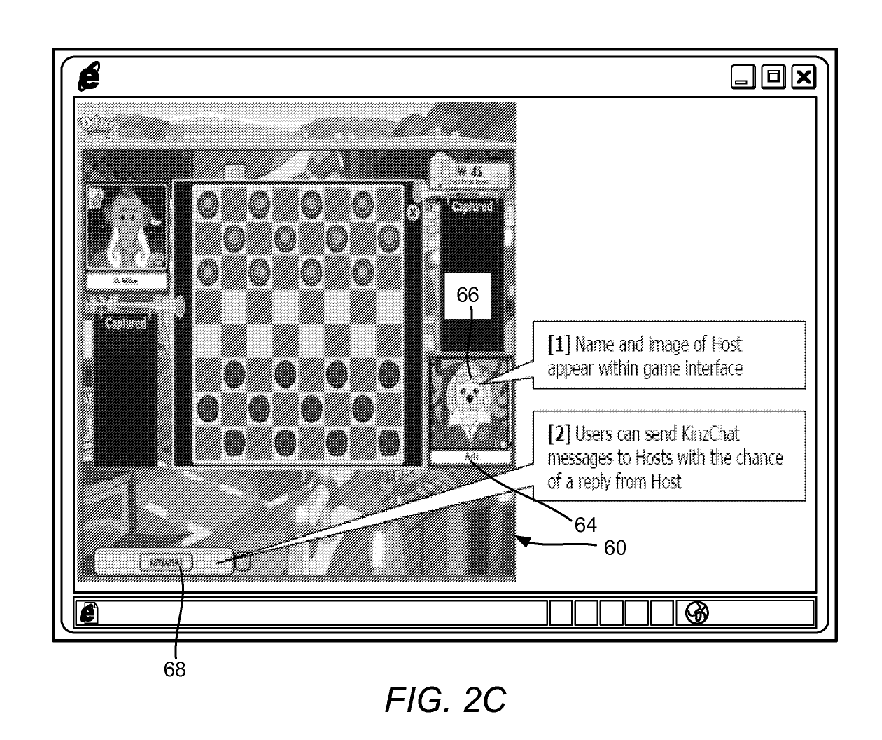

Regardless of whether the tournament area is restricted or not, upon accessing the tournament area within the virtual world 22, the user is presented with a tournament interface 36 shown in FIG. 2A. Accessing the tournament area can be accomplished by the user by navigating the virtual character 30 to a predetermined location in the virtual world 22 (e.g., a location where the host non-player character 20 can be found), by selecting an appropriate menu option, selection the location on a map, etc. . . . Once the user has accessed the tournament area, the tournament interface 36 presented to the user (e.g., transmitted over the communication network 18, loaded locally by the user computer 12a, etc. . . . ) includes a plurality of activities 34 the user can participate in, and a list of friends 37 identifying the user's friends who are also present within the tournament area, including any non-player characters 20, whom the user can select to also participate in a selected activity 34. The status indicator 38 indicates that the entry 40 corresponding to the non-player character 20 named “Arte Fact” in the user's list of friends 37 is present in the tournament area, and available to participate in an activity 34. The status indicators 42 for entries 44, corresponding to the user's human friends who are included on the user's list of friends 37 and are also present in the tournament area, can indicate whether those friends are available to participate in an activity 34. For instance, the status indicator 42 can change appearance to indicate whether the friends corresponding to each entry 44 are online, offline, busy, already participating in an activity 34, etc. . . .

FIG. 2B shows an illustrative embodiment of a matchup interface 50 that includes the activity's name 52, the participants 54 involved in the activity 34, and an indication 56 whether any non-player characters 20 (or other participants) are competing with, or against the user. In this example, the indicator 56 is “vs”, indicating that the non-player character 20 is competing against the user, who is represented by the virtual character 30.

FIG. 2C shows an illustrative embodiment of an activity interface 60, where the user is competing in an activity against the other participant, who in the present example is a non-player character 20. FIG. 2C, for example, shows the activity 34 being a checkers game. In addition to the playing board 62 or other field of play, the name 64 and likeness 66 of the non-player character 20 hosting the activity 34 is displayed in the activity interface 60. A chat interface 68 can also optionally be available to the user in the activity interface 60. The chat interface 68 receives input from the user for composing a message to be conveyed to the non-player character 20 participating in the activity 34. A collection of available, pre-defined responses can optionally be stored in a non-transitory computer memory provided to one or more of the user computer 12a and the server 14a. Once a message from the user to the non-player character 20 is received, at least one of the user computer 12a and server 14a can evaluate the message content to determine if a suitable response is stored in the collection. Each response can optionally be associated with one or more messages from users, and a lookup table or other mapping algorithm relating each response to received messages can optionally facilitate selection of the appropriate response based, at least in part, on the content of the message received from the user. The appropriate response, if available and identified, can be transmitted to the user from the non-player character 20. If an appropriate response does not exist or cannot be identified, no response may be transmitted from the non-player character, or a predetermined generic response can be conveyed.

Multiple non-player characters may exist in the virtual world 22. However, in some embodiments, only a selected subset of non-player characters may be befriended by users or the user's virtual character. In still yet another embodiment of the invention, only a sub-set of the available non-player characters in the virtual world may be befriended by users to grant those users access to restricted portions of the virtual world 22. In other words, a user can befriend and add a virtual character included in this subset to that user's list of friends in order to gain access to the restricted portion of the virtual world 22. In contrast, access to the restricted portion of the virtual world 22 will not be granted to the user for befriending and adding a virtual character that is not included in this subset to that user's list of friends. Additionally, users may be provided with awards or gifts, based at least in part, upon befriending a non-player character. For example, a non-player character may give a user a gift or award on the user's registered birthday or may award virtual currency or virtual items on the anniversary of the friendship being commenced.

The virtual friendship between the user and the non-player character can optionally be tracked and maintained as a friendship level that represents the “closeness” of the friendship between the user and the non-player character. Metrics associated with the friendship level may include, for example, the number of interactions between the user and a non-player character, number of challenges from the non-player character completed by the user, number of messages sent by the user to the non-player character, and the date of the relationship's initiation. These metrics may be stored on the server computer, for example.

In still another embodiment, the friendship level is used to determine the value of an award or gift given to the user. The gift or award may be presented by the non-player character. The friendship level may also be used to determine the frequency when a non-player character presents a challenge to the user that includes a reward given for completion of the challenge. As the friendship level increases between a user and a non-player character, the value of a gift being given by the non-player character to the user may increase as a function of friendship level increase. Similarly, as the friendship level between a user and a non-player character decreases, the value of the awards or gifts presented to the user may also decrease as a function of the friendship level. Friendship levels may decrease in response to a user's inactivity in the virtual world 22, a lack of interaction between the user and the non-player character, or a frequency of interaction between the user and the non-player character tracked over a time interval. In some instances, the friendship level tracking system may also be used to determine when a non-player character de-friends a particular user. The friendship level and related metrics encourage users to maintain or increase their relationships in the virtual world 22 and specifically encourages relationships with non-player characters. Thus, relationship tracking can increase the amount of time that a user spends in a virtual world 22 and therefore increase the number of users active in the virtual world 22 at a given time.

In another embodiment, the user can also optionally be presented with one, or a plurality of challenges, each including a plurality of activities to be performed by the user as a condition of gaining access to the restricted portion of the virtual world 22. The multiple activity challenges, interchangeably referred to herein as “multi-step challenges”, may be presented by the non-player character due to an interaction with the non-player character or due to the friendship level with the non-player character. In order for the multi-step challenges to be presented by the non-player character, the user is required to interact with the non-player character (optionally required to be a non-player character with which a friendship has been established) in the virtual world 22, and the non-player character is to communicate with the user (e.g., audibly, visually, a combination thereof, etc. . . . ) to create the impression that the non-player character is the party presenting the opportunity to participate in the activities making up the challenges presented to the user. In other words, the non-player character appears to be issuing the multi-step challenge to the user, or a virtual character controlled by the user. Successful completion of a multi-step challenge by the user may result in one or more of: increasing the closeness of a friendship level between the user and the non-player character, unlocking a restricted portion of the virtual world 22 to the user, and granting of an award or gift to the user. Additionally, simply interacting with the non-player character assigning the challenge, which can optionally be a multi-step challenge, to the user can constitute an interaction that improves the closeness of the friendship between that non-player character and the user. This friendship can optionally deteriorate over time in the absence of interactions between the user and the non-player character.

According to an illustrative embodiment, progress in a challenge comprising a plurality of activities can be saved, allowing the user to resume progress where performance of the challenge was previously suspended. The activities can optionally be sequential, requiring completion in a predetermined order, and progress can optionally be saved on an activity-by-activity basis (i.e., the challenge can be resumed at a time following the last, successfully completed activity in the challenge). The user in the midst of a multiple step challenge can also optionally be presented with a hint option that may be selected by the user. The hint option, if selected, may provide a hint that assists the user in completing one or more of the steps in the multiple step challenge. The hint option may include a cost to the user associated with selecting the hint option. For example, the user may have to pay virtual cash or virtual currency from the user's virtual cash account.

An example of a virtual world 22 Host or non-player character giving the user a challenge is presented as follows. A portrait of the Host appears in a system message to the user in the form of a “welcome message” that may be unique for each host. The welcome message may be triggered each time a user adds a Host to their Friend's list. A “New Friend Welcome Messages” for each Host may be a script that appears within a thought bubble with a visual representation of the Host. The thought bubble will imply the Host has a challenge that may include a multiple step challenge waiting for user. The user's clicking on a thought bubble then triggers a specific challenge that is introduced to the user though the Host “Challenge Dialogue.”

A challenge interface in another example embodiment includes the image of the Host that is offering the challenge. In one challenge, the image of the Host's desk acts as the “target” to deposit food. If a user is asked to bring a Host a non-food item, the target would feature an image of the Host's desk with a clean surface. To complete the challenge, the user would find food in the virtual world 22 and then drag and drop the food onto the Host's desk. In other challenges, the user would be tasked to find, drag, and drop other virtual items into the Host's area.

In another example, the Host may have an explicit challenge that is given to the user and the user may accept the challenge by selecting a virtual button or other virtual selector. Alternatively, the user could choose to close the challenge from the Host and not participate.

A “Gift Box” icon may be included that activates a prize interface. When selected, this interface may show prizes, gifts, and awards to the user when the challenge is completed. The prize interface may state “Win one of these prizes by completing your Challenge with HOST A.” The prize interface may replace the challenge or challenge interface to allow for smooth transition from the prize interfaces directly to the challenge without going through the challenge interface. The prize interface is dynamic as each Host will offer a different variety of prizes.

A hint option may also state “Give Me a Hint” or “Would you like to but a hint for $X of virtual currency” with user selectable buttons that state “yes” or “no.” Additionally, there may be an “I give up” button or a “complete the challenge” button to allow the user to select discontinuing the challenge. When a user discontinues the challenge, the number of open challenges is decremented by one.

In some embodiments, the number of open challenges may be limited. For example, challenges may continue over a period of hours or days. A user may be allowed to start a first challenge and while still performing the challenge start a second challenge. However, the system may limit the user to participating in three challenges simultaneously. Therefore, after a third challenge is started, while the first and second challenges are ongoing, a fourth challenge may not be started until the user either completes one of the three challenges or discontinues one of the three challenges.

In another embodiment, the challenge interface can be accessed by clicking on a challenge icon at the bottom left corner of the screen, or another position relative to the host appearing on the screen. When the challenge interface is opened or closed, the interface appears to “zoom” in and out of the challenge icon. The challenge icon may be a unique icon that implies a challenge is waiting. The challenge icon could appear to be floating in front of a Host or the Host's desk, or could appear to be sitting on the desk itself.

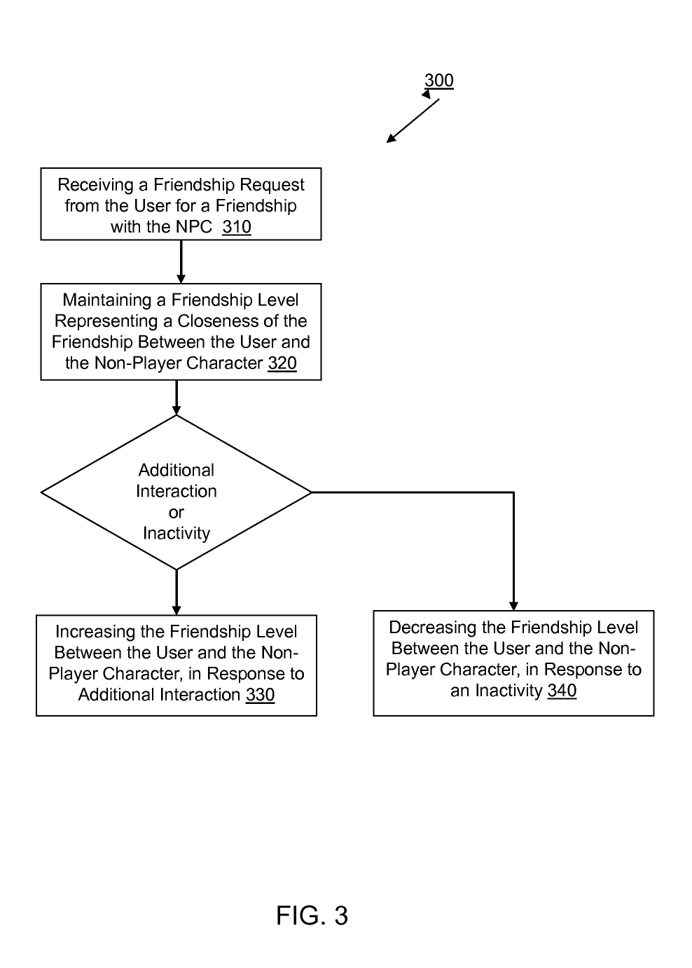

FIG. 3 depicts many of the techniques described above as implemented on a computer, as a flowchart 300 for creating and maintaining a friendship between a user and a non-player character. The flow starts by receiving a friendship request from the user for a friendship with a non-player character 310. The method 300 further includes maintaining a friendship level representing a closeness of the friendship between the user and the non-player character 320. The friendship level may be used to increase 330 or decrease 340 a value of a gift to the user, a value of an award to the user, a frequency of presenting multiple step challenges to the user, or a level of difficulty of the multiple step challenges. The method 300 also includes increasing the friendship level between the user and the non-player character, in response to additional interactions 330 by the user with the non-player character after establishing the friendship. The method 300 also includes decreasing the friendship level between the user and the non-player character, in response to an inactivity 340 or a lack of interactions for a period of time between the user and the non-player character.

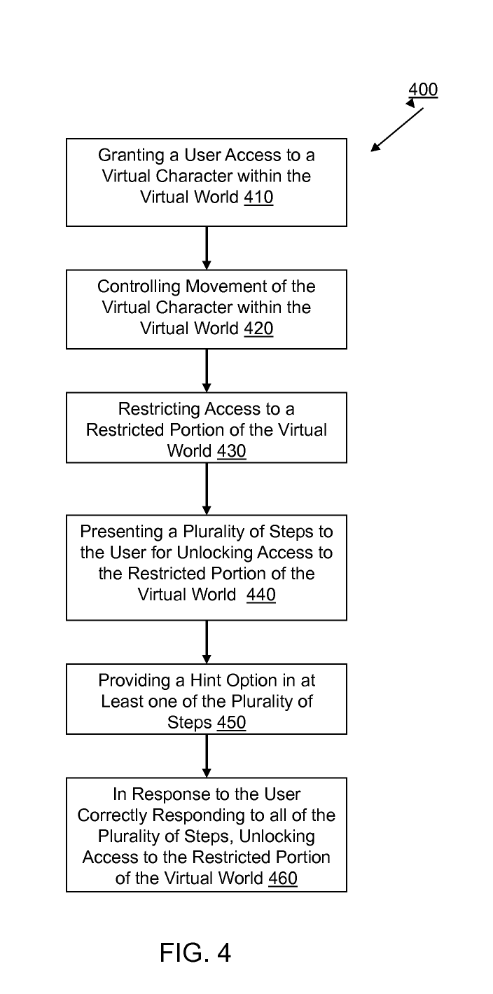

FIG. 4 shows a flowchart 400 of operation for unlocking portions of a virtual world 22 as described above. The flow 400 includes granting a user access to a virtual character within the virtual world 410 and in response to receiving input commands from the user, controlling movement of the virtual character within the virtual world 22 in a manner consistent with the input commands 420. The method 400 also includes restricting access to a restricted portion of the virtual world 430 to prevent the user from participating in activities or entering a restricted portion of the virtual world 22.

The flow 400 further includes presenting a plurality of steps to the user for unlocking access to the restricted portion of the virtual world 440 and requiring the user to complete a current event in each one of the plurality of steps before attempting a subsequent event. The plurality of steps may be challenges or multiple step challenges. The events may represent steps within the plurality of steps. In some embodiments, the user is not required to successfully complete each step correctly in the plurality of steps to successfully complete the plurality of steps. For example, if the plurality of steps is a series of 10 questions, the user may only be required to answer 7 questions correctly to complete the plurality of steps.

The flow 400 also includes providing a hint option in at least one of the plurality of steps 450. If the hint option is chosen by the user, the system will assist the user in completing the current event by providing hints, clues, or other information to help the user complete the step, a series of steps, or a task in a challenge or in the plurality of steps. For example, if the plurality of steps is a series of 15 questions, the hint may assist the user in answering one or more of the 15 questions. The plurality of steps may be associated with Host challenges or multiple step challenges. The method 400 also includes, in response to the user correctly responding to all of the plurality of steps, unlocking access to the restricted portion of the virtual world 22. The restricted portion of the virtual world 22 may be an area of the virtual world 22 or an activity or set of activities associated with the virtual world 22, the user, or the non-player character.

In one embodiment, the plurality of steps is a sequence of challenges used to unlock the restricted portion of the virtual world 22. For example, the sequence of challenges may be a set of questions for the user to answer or a series of objects to find within the virtual world 22. In some embodiments, the user may participate in multiple sequences of challenges or plurality of steps simultaneously. The number of the sequences of challenges that can be participated in simultaneously may be limited to a set number of sequences of challenges. Additionally, a hint option may be presented to the user for giving the user hints to assist in completion of the sequence of challenges. In still another embodiment, the presentation of the sequence of challenges is dependent upon the user befriending a non-player character.

1. A method of interacting with a non-player character in a virtual world, the method comprising:
with a computer system, granting a user access to an interface allowing the user to establish a friendship with a computer-controlled character that is controlled in an automated manner within the virtual world by the computer system instead of being manually controlled by a human user;
receiving, with the computer system, a friendship request entered by the user via the interface requesting the friendship with the computer-controlled character;
in response to said receiving, establishing the friendship by adding the computer-controlled character to a list of friends associated with the user; and
subsequent to said establishing the friendship with the computer-controlled character, granting the user access to a restricted portion of the virtual world that was not accessible to the user before the user entered the friendship request.

2. The method of claim 1, wherein access to the restricted portion of the virtual world is restricted by the computer system to a subset of users who have each established a friendship with a computer-controlled character.

3. The method of claim 2, wherein the restricted portion of the virtual world comprises an activity presented by the computer-controlled character to the user, to be performed in the virtual world by a virtual character controlled by the user.

4. The method of claim 3, wherein the activity comprises a game to be played against the computer-controlled character with a virtual character controlled by the user, the method further comprising awarding a prize to the user for successfully completing the game.

5. The method of claim 3, wherein the activity comprises a plurality of different difficulty levels, the method further comprising:
awarding a first prize having a first value in the virtual world for completing a relatively-difficult activity; and
awarding a second prize having a lesser value in the virtual world than the first prize for completing a relatively-easy activity.

6. The method of claim 5, further comprising providing the user with a gift from the computer-controlled character based, at least in part, on the computer-controlled character being added to the list of friends associated with the user.

7. The method of claim 3 further comprising providing the user with an option that is selectable to receive a hint that will assist the user in completing the activity.

8. The method of claim 1 further comprising granting the user the ability to transmit a communication to the computer-controlled character in response to establishing the friendship, wherein transmission of the communication from the user to the computer-controlled character was restricted before the user entered the friend request, and wherein the communication comprises at least one of a written communication and a gift.

9. The method of claim 8 further comprising transmitting a response to receiving the communication from the computer-controlled character to the user with the computer system, the response comprising at least one of a written response, an audible response, a visual response, and a return gift.

10. The method of claim 1, further comprising maintaining a friendship level representing a closeness of the friendship between the user and the computer-controlled character.

11. The method of claim 10, further comprising adjusting the friendship level between the user and the computer-controlled character based at least in part on interactions between the user and the computer-controlled character after establishing the friendship.

12. The method of claim 11, wherein the closeness of the relationship level is improved in response to additional interactions between the user and the computer-controlled character after the friendship is established, and the closeness of the relationship level is deteriorated in response to an absence of said additional interactions for a predetermined period of time after the friendship is established.

13. The method of claim 10, wherein the friendship level is used by the computer system to establish at least one of: a value of a gift from the computer-controlled character to the user, a frequency at which challenges are made available to the user, and a level of difficulty of a challenge made available by the computer-controlled character to the user.

14. A method of granting access to a portion of a virtual world, the method comprising:
with a computer system, restricting access to a restricted portion of the virtual world to prevent a user from accessing the restricted portion of the virtual world while allowing the user to access other portions of the virtual world;
establishing a plurality of activities in the virtual world to be completed as part of a challenge, wherein the plurality of activities included in the challenge are a condition for granting the user access to the restricted portion of the virtual world;
issuing the plurality of activities to the user from a computer-controlled character presented in the virtual world; and
in response to the user successfully completing each of the plurality of activities, using the computer system to grant the user access to the restricted portion of the virtual world.

15. The method of claim 14 further comprising providing a hint option that the user can select to receive a hint that will assist the user in completing at least one of the activities.

16. The method of claim 14 further comprising assigning a cost associated with selection of the hint option, and charging the cost to the user in response to selection of the hint option.

17. The method of claim 14, wherein the plurality of activities included in the challenge are sequential, requiring completion in a predetermined order as the condition for granting the user access to the restricted portion of the virtual world.

18. The method of claim 17 further comprising saving progress made by the user in the challenge, allowing the user to resume performance of the challenge at a select activity where the user previously suspended the challenge.

19. The method of claim 18 further comprising issuing a second challenge comprising a plurality of activities to the user from a different computer-controlled character presented in the virtual world while performance of the challenge is suspended.

20. The method of claim 14, further comprising awarding a prize to the user in response to correctly responding to all of the plurality of activities.

21. The method of claim 14, wherein said issuing the plurality of activities comprises:
determining whether a friendship has been established between the user and the computer-controlled character that is to issue the plurality of activities to the user in the virtual world; and
issuing the plurality of activities to the user only in response to a determination that the friendship between the user and the computer-controlled character that is to issue the plurality of activities to the user has been established.

22. A method of interacting with a computer-controlled character, comprising:
with a computer system, restricting access to a restricted portion of the virtual world;
with the computer system, granting a user access to an interface allowing the user to establish a friendship with a computer-controlled character;
receiving, with the computer system, a friendship request entered by the user via the interface requesting the friendship with the computer-controlled character;
in response to said receiving, establishing the friendship by adding the computer-controlled character to a list of friends associated with the user;
granting the user access to a restricted portion of the virtual world that was not accessible to the user before the user entered the friendship request;
establishing a plurality of activities in the virtual world to be completed as part of a challenge, wherein the plurality of activities included in the challenge are a condition for granting the user access to another restricted portion of the virtual world;
issuing the plurality of activities to the user from the computer-controlled character in the virtual world that has the friendship established with the user; and
in response to the user successfully completing each of the plurality of activities, using the computer system to grant the user access to the another restricted portion of the virtual world.

23. A computer running a program establishing a virtual world, comprising:
a computer system, programmed to connect to a network and to connect to multiple users over the network,
the computer system allowing a user to become friends with a computer-controlled character that is not being controlled by a user, the allowing carried out by receiving a friend request entered by the user via the interface requesting a friendship with the computer-controlled character;
the computer system establishing the friendship by adding the computer-controlled character to a list of friends associated with the user; and
the computer system operating to grant the user access to a restricted portion of the virtual world that was not accessible to the user before the computer controlled character was added to the list of friends associated with the user.
